(19) United States
(12) Patent Application Publication
(10) Pub. No.: US 2012/0169213 A1
(43) Pub. Date: Jul. 5, 2012

(54) PHOSPHORESCENT METAL COMPLEX COMPOUND, METHOD FOR THE PRODUCTION THEREOF AND RADIATION EMITTING STRUCTURAL ELEMENT

(75) Inventors: Luisa De Cola, Muenster (DE); David Hartmann, Erlangen (DE); Wiebke Sarfert, Herzogenaurach (DE); Günter Schmid, Hemhofen (DE); Sabine Szyszkowski, Dachsbach (DE); Cheng-Han Yang, Muenster (DE)

(73) Assignee: OSRAM AG, Muenchen (DE)

(21) Appl. No.: 13/381,978

(22) PCT Filed: May 5, 2010
(86) PCT No.: PCT/EP2010/056111

§ 371 Date: Mar. 8, 2012

(30) Foreign Application Priority Data
Jul. 3, 2009 (DE) 10 2009 031 683.3

(51) Int. Cl. H05B 33/14; C07F 15/00; H05B 33/20

(52) U.S. Cl. 313/502; 313/504; 546/4

(57) ABSTRACT

A phosphorescent metal complex may include at least one metallic central atom M; and at least one ligand coordinated by the metallic central atom, wherein one ligand is bidentate with two uncharged coordination sites and comprises at least one carbene unit coordinated directly to the metal atom.

The invention relates to a phosphorescent metal complex, to processes for preparation thereof and to a radiation-emitting component, especially an organic light-emitting electrochemical cell (OLEEC).

In contrast to the widely known and already frequently discussed OLEDs, the OLEECs are notable particularly for a much simpler structure since an organic active layer is usually required here, and the latter is applicable by means of wet-chemical methods.

In the organic light-emitting diodes (OLEDs), especially in the OLEDs formed with what are called small molecules, what is called a multilayer structure is implemented because, in addition to the light-emitting layer, efficiency-increasing layers such as hole and/or electron injection layers are also arranged between the electrodes for better transfer of the charge carriers. Often, high-reactivity materials are used, such that the encapsulation is one aspect which plays a crucial role for the lifetime of the light-emitting element, since it protects the auxiliary layers from decomposition.

Since the reactive electrodes of the OLED can be dispensed with in the OLEECs, the entire encapsulation problem in the case of the OLEECs is not as serious as in the case of the OLEDs. The OLEECs are therefore considered to be a promising substitute for the OLEDs.

Quite generally, organic electroluminescent elements have at least one organic layer present between two electrodes. As soon as voltage is applied to the electrodes, electrons are injected from the cathode into the lowest unoccupied molecular orbitals of the organic light-emitting layer and migrate toward the anode. Correspondingly, holes are injected from the anode into the highest occupied molecular orbitals of the organic layer and migrate accordingly to the cathode. In the cases where migrating hole and migrating electron encounter a light-emitting substance within the organic light-emitting layer, an exciton forms, which decomposes with emission of light. In order that the light can leave the electroluminescent element at all, at least one electrode must be transparent, in most cases an electron composed of indium tin oxide which is used as the anode. The ITO layer is normally deposited on a glass carrier.

However, there is still not an adequate selection of suitable materials for the emitting layers; more particularly, there is a lack of blue/green-emitting materials.

It is therefore an object of the present invention to provide a material class which, in addition to use in emitting components in general, is also suitable for use as an iTMC in OLEEC cells, and to specify a synthesis therefor; it is a further object of the invention to specify an example for the use of the material in an emitting component such as an OLEEC cell.

The subject matter of the invention and the solution to the problem are disclosed by the claims, the description and the figures.

Accordingly, the invention provides a phosphorescent metal complex which includes at least one metallic central atom M and at least one ligand coordinated by the metallic central atom, wherein one ligand is bidentate with two uncharged coordination sites and includes at least one carbene unit coordinated directly to the metal atom. The invention also provides a radiation-emitting component including a substrate, a first electrode layer on the substrate, at least one organic emitting layer on the first electrode layer and a second electrode layer on the organic emitting layer, wherein the organic emitting layer includes a phosphorescent metal complex as claimed in the invention. Finally, the invention provides a process for preparing a phosphorescent metal complex including the process steps of

A) providing an organometallic complex with a metallic central atom, having exchange ligands coordinated to the central atom, i.e. ligands which leave easily and can thus be exchanged efficiently,
B) mixing the central atom compound and an uncharged ligand dissolved in a first solvent with a carbene unit to form the metal complex, the exchange ligand being replaced by the ligand which coordinates in a bidentate manner to the central atom and includes a carbene unit.

More particularly, the phosphorescent metal complex is a material class of a metal complex of the following general structure I:

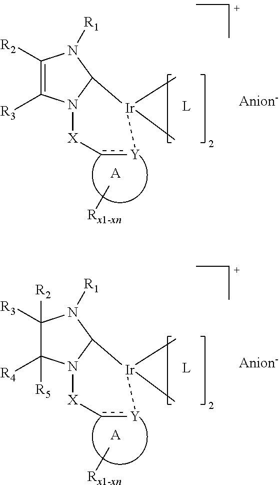

Structure I: The two additional ligands L, symbolized by the square brackets, are selected from the conventional cyclometallizing ligands, as described, for example, in WO2005097942A1, WO2006013738A1, WO2006098120A1, WO2006008976A1, WO2005097943A1, (Konica Minolta) or U.S. Pat. No. 6,902,830, U.S. Pat. No. 7,001,536, U.S. Pat. No. 6,830,828 (UDC). They are all bonded to iridium via an N̂C— unit. Example: 2-phenylpyridine or 2-phenylimidazole and related structures, for example benzimidazole or phenanthridine. Particularly the 2-phenylimidazole derivatives are known for a shift in the emission into the blue-green to blue spectral region.

In further advantageous embodiments, the two known ligands L may have, for example, a further carbene functionality which serves as a source of deep blue emission. Examples of these ligands L can be found in publications WO200519373 and EP1692244B1.

Further examples of possible ligands L are known from publications EP1904508 A2, WO 2007004113 A2, WO2007004113R4A3, and these ligands L are also shown in the context of charged metal complexes which have at least one phenylpyridine ligand with appropriate donor groups such as dimethylamino. These compounds exhibit an elevated LUMO level of the complex, with acceptor groups, for example 2,4-difluoro, introduced into the phenyl ring in order to lower the level of the HOMO orbital. It is shown that the variation of the ligands and the substituents thereof allows the emission color to be varied through the entire visible spectrum.

In addition to the two ligands L, the metal complex of the structural formula I has a ligand which is preferably bidentate and uncharged and contains at least one carbene ligand. The result is thus a structure of the general formula I.

In one embodiment of the material class, the two ligands L symbolized by the brackets and already known in the literature are preferably cyclometallizing ligands selected from the following documents: WO2005097942A1, WO2006013738A1, WO2006098120A1, WO2006008976A1, WO2005097943A1, WO2006008976A1 (Konica Minolta) or U.S. Pat. No. 6,902,830, U.S. Pat. No. 7,001,536, U.S. Pat. No. 6,830,828, WO2007095118A2, US20070190359A1 (UDC), EP1486552B1.

In general, all R radicals=independently H, branched alkyl radicals, unbranched alkyl radicals, fused alkyl radicals, cyclic alkyl radicals, fully or partly substituted unbranched, branched, fused and/or cyclic alkyl radicals, alkoxy groups, amines, amides, esters, carbonates, aromatics, fully or partly substituted aromatics, heteroaromatics, fused aromatics, fully or partly substituted fused aromatics, heterocycles, fully or partly substituted heterocycles, fused heterocycles, halogens, pseudohalogens.

All substituents R₁, R₂, R₃ may each independently be selected from the abovementioned radicals, which are preferably C1 to C20, fused, e.g. decahydronaphthyl, adamantyl, cyclic, cyclohexyl, or fully or partly substituted alkyl radical, preferably C1 to C20. These chains or groups may bear different end groups, for example charged end groups such as SOₓ⁻, NR⁺ and so forth.

The alkyl radicals may in turn bear groups such as ether, ethoxy, methoxy, etc., ester, amide, carbonate, etc., or halogens, preferably fluorine. R₁, R₂ and R₃ should not, however, be restricted to alkyl radicals, but may equally include substituted or unsubstituted aromatic systems, for example phenyl, biphenyl, naphthyl, phenanthryl, benzyl, and so forth. A summary of the most important representatives can be seen in table 1 below.

TABLE 1
A selection of substituted and unsubstituted
heterocycles which are possible R_{x1-Xn}, or R₁, R₂, R₃,
radicals.

| | |
|---|---|
| 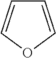 Furan | 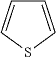 Thiophene |
| 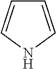 Pyrrole | 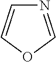 Oxazole |
| 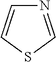 Thiazole | 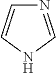 Imidazole |
| 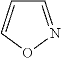 Isoxazole | 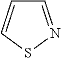 Isothiazole |
| 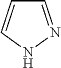 Pyrazole | 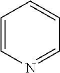 Pyridine |
| 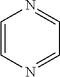 Pyrazine | 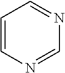 Pyrimidine |
| 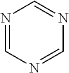 1,3,6 Triazine | 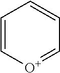 Pyrylium |
| 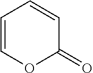 alpha-Pyrone | 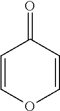 gamma-Pyrone |
| 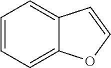 Benzo [b] furan | 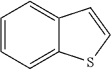 Benzo [b] thiophene |
| 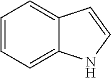 Indole | 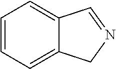 2H-Isoindole |
| 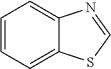 Benzothiazole | 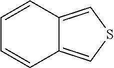 2-benzothiophene |
| 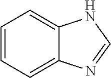 1H-benzimidazole | 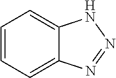 1H-benzotriazole |
| 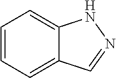 1H-indazole | 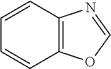 1,3-benzoxazole |
| 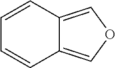 2-benzofuran | 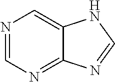 7H-purine |
| 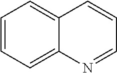 Quinoline | 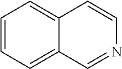 Isoquinoline |
| 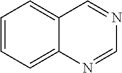 Quinazoline | 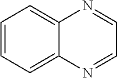 Quinoxaline |
| 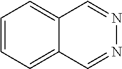 phthalazine | 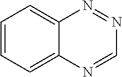 1,2,4-benzotriazine |
| 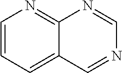 Pyrido[2,3-d] pyrimidine | 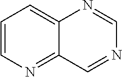 Pyrido[3,2-d] pyrimidine |
| 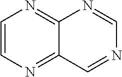 pteridine | 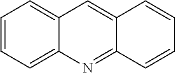 acridine |
| 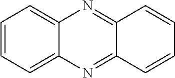 phenazine | 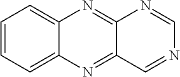 benzo[g]pteridine |
| 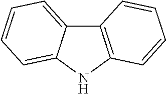 9H-carbazole | 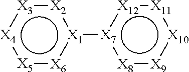 Bipyridine & derivatives (0-2Xᵢ/ring = N) |

For the sake of simplicity, only the base unit is shown. Derivatives thereof are also encompassed by the invention. The bond to the ligand may be at any bonding-capable site on the base structure.

R₁, R₂ and R₃ may also each independently be bridged to one another. For example, benzimidazole derivatives form when R₂ and R₃ in structure I are bridged and form an aromatic ring. The benzimidazole base structure which forms the carbene unit may likewise be substituted, as mentioned above.

Preferred variants of the X bridge are (—CR_{b1}R_{b2}—)ₙ, (—SiR_{b1}R_{b2}—)ₙ and —N—R_{b1}, P—R_{b1} or O, S, Se. The length of the bridge n may be in the range of 0-10, preferably 0 or 1. This bridge serves to configure the bonding conditions on the iridium in a coordinative and hence energetically favorable manner. The bridge radicals can be selected from the above lists analogously to R_{x1-Xn}, R₁, R₂, R₃.

The cycle A is preferably, but without restriction, again a substituted or unsubstituted aromatic from the group of the aromatics shown in table 1, with the boundary condition that the coordination site Y can interact in a coordinative manner with the central iridium atom. Y is preferably not C in the sense of a cyclometallization, but is N, P, O or S. The aromatic ring is preferably 5- or 6-membered. Further aromatic rings may be fused to this aromatic ring. Especially in the case of N and P, no ring system A need be attached. Here, the PR₁R₂ or NR₁R₂ itself is sufficient.

In another embodiment of the material class, R₁ and/or R₂ are bonded to other R₁′ and/or R₂′ radicals of a further metal complex. The bonding group may be taken from the examples given below. If higher-functionality bonding members are selected, there is access to more highly crosslinked complexes up to and including polymeric complexes. On the other hand, a bridge may also be formed via one of the known ligands L to one or more further complexes with ligands and central atoms. In this way too, access to oligomeric and polymeric compounds is thus possible.

Y═C, usually in conjunction with n=1 and X═(—CR_{b1}R_{b2}—), when the cycle/aromatic ring A is in turn a carbene. In this case, the result is the following general formula (structure II)

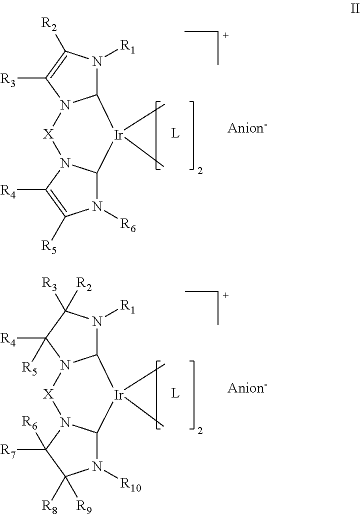

Structure II: General formula for a preferred embodiment of the OLEEC emitters according to the invention with two carbene units in one bidentate ligand.

For the R₁ to R₁₀ radicals, the same conditions apply as for the structures shown in structure I; all substituents R may independently be H, methyl, ethyl, or generally linear or branched, fused (decahydronaphthyl, adamantyl), cyclic (cyclohexyl) or fully or partly substituted alkyl radicals (C1-C20). The alkyl groups may be functional groups such as ethers (ethoxy, methoxy, etc.), esters, amides, carbonates, etc., or halogens, preferably F. R is not restricted to radicals of the alkyl type, but instead may have substituted or unsubstituted aromatic systems, heterocycles, such as phenyl, biphenyl, naphthyl, phenanthryl, etc., and benzyl, etc.

For the sake of simplicity, table 1 shows only the basic structures. Substitutions may occur here at any position with a potential bonding valency.

The R radical may equally be of organometallic nature, for example ferrocenyl or phthalacyaninyl.

Preferably, but without restriction, the anions are selected from: fluoride, chloride, bromide, iodide, sulfate, phosphate, carbonate, trifluoromethanesulfonate, trifluoroacetate, tosylate, bis(trifluoro-methylsulfone) imide, tetraphenylborate, B₉C₂H₁₁²; hexafluorophosphate, tetrafluoroborate, hexafluoro-antimonate.

Preferably, M=iridium. However, other possible metals include those such as Re, Ru, Rh, Os, Pd, Au, Hg, Ag and Cu. The stoichiometry of the corresponding complexes will then vary according to the coordination sphere of the respective central atom, especially because not all metals form octahedral complexes like iridium.

Thus, in the case that M=Ir, singly positively charged ionic transition metal complexes are obtained (cation). The charge of the cation is compensated for by an anion.

In another embodiment of the material class, R₁ and/or R₂ is bonded to other R₁′ and/or R₂′ radicals of a further metal complex. The bonding group may be taken from the examples given below. If higher-functionality bonding members are selected, there is access to more highly crosslinked complexes up to and including polymeric complexes. On the other hand, a bridge can also be formed via one of the known ligands L to one or more further complexes with ligands and central atoms. In this way too, access is thus possible to oligomeric and polymeric compounds.

The above-described materials are used as emitter material in light-emitting components which, in an advantageous embodiment, are what is called a light-emitting electrochemical cell, known as OLEEC (organic light-emitting electrochemical cell).

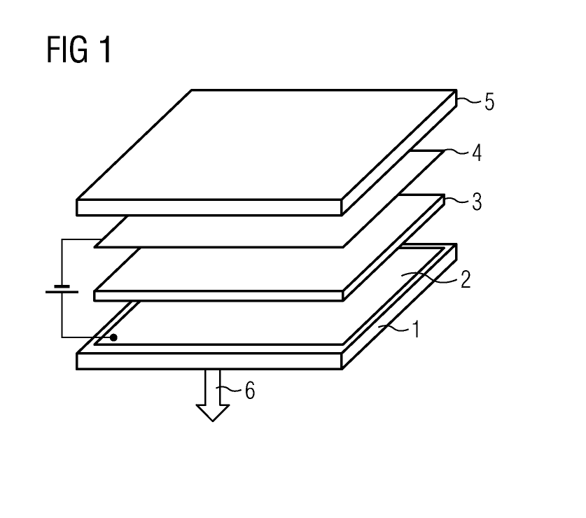

FIG. 1 shows a schematic of the structure of an OLEEC.

An OLEEC 7 is in principle of simpler construction than the OLED, and in most cases can be implemented by simple introduction of an organic layer 3 between two electrodes 2 and 4 and subsequent encapsulation 5. On application of voltage, light 6 emerges. The preferably one active emitting layer 3 of an OLEEC consists of a matrix into which an emitting species has been embedded. The matrix may consist of an insulator or of a material which is either an ion conductor with electrolyte properties or an inert matrix (insulator). The emitting species is/are one or more ionic transition metal complexes (iTMC for short), for example tri sbipyridineruthenium hexafluorophosphate [Ru(bpy)₃]²⁺(PF₆⁻)₂, in a polymeric matrix.

Atop the transparent substrate 1 is the lower electrode layer 2, for example the anode. Above this is the actually active emitting layer 3 and above that the second electrode 4. For better performance and processing, the emitter material (iTMC) which forms the active layer 3, i.e. the phosphorescent metal complex, is dissolved in a solvent together with a matrix material. Preferably, but without restriction, the following solvents are used: acetonitrile, tetrahydrofuran (THF), toluene, ethylene glycol diethyl ether, butoxyethanol, chlorobenzene, propylene glycol methyl ether acetate, further organic and inorganic and polar or nonpolar solvents and solvent mixtures are also usable in the context of the invention. The soluble matrix materials which are used in conjunction with iTMCs are, for example, polymers, oligomers and ionic liquids.

Examples of polymeric matrix materials (high molecular weight) are, alongside many others: polycarbonate (PC), polymethyl methacrylate (PMMA), polyvinylcarbazole (PVK). As well as these “electrically insulating” materials, it is also possible to use polymeric hole transporters. Typical representatives are: PEDOT (poly-(3,4-ethylenedioxythiophene)), poly(N,N′-bis(4-butylphenyl)-N,N′-bis(phenyl)benzidine) (PTPD), polyanilines (PANI) and poly(3-hexylthiophene) (P3HT). From these materials, it is possible to use any copolymers and/or block copolymers, which may also contain “insulating” but, for example, solubilizing units. Examples thereof are polystyrene, ABS, ethylene units, vinyl units, etc.

Materials with low molecular weight, called small molecules, can likewise be used.

Various examples are enumerated hereinafter for hole transporter materials with low molecular weight:
N,N′-bis(naphthalen-1-yl)-N,N′-bis(phenyl)-9,9-dimethylfluorene
N,N′-bis(3-methylphenyl)-N,N′-bis(phenyl)-9,9-diphenylfluorene
N,N′-bis(naphthalen-1-yl)-N,N′-bis(phenyl)-9,9-diphenylfluorene
N,N′-bis(naphthalen-1-yl)-N,N′-bis(phenyl)-2,2-dimethylbenzidine
N,N′-bis(3-methylphenyl)-N,N′-bis(phenyl)-9,9-spirobifluorene
2,2′,7,7′-tetrakis(N,N-diphenylamino)-9,9′-spirobifluorene
N,N′-bis(naphthalen-1-yl)-N,N′-bis(phenyl)benzidine
N,N′-bis(naphthalen-2-yl)-N,N′-bis(phenyl)benzidine
N,N′-bis(3-methylphenyl)-N,N′-bis(phenyl)benzidine
N,N′-bis(3-methylphenyl)-N,N′-bis(phenyl)-9,9-dimethylfluorene
N,N′-bis(naphthalen-1-yl)-N,N′-bis(phenyl)-9,9-spirobifluorene
di[4-(N,N-ditolylamino)phenyl]cyclohexane
2,2′,7,7′-tetra(N,N-ditolyl)aminospirobifluorene
9,9-bis[4-(N,N-bis(biphenyl-4-yl)amino)phenyl]-9H-fluorene
2,2′,7,7′-tetrakis[N-naphthalenyl(phenyl)amino]-9,9-spirobifluorene
2,7-bis[N,N-bis(9,9-spirobifluoren-2-yl)amino]-9,9-spirobifluorene
2,2′-bis[N,N-bis(biphenyl-4-yl)amino]-9,9-spirobifluorene
N,N′-bis(phenanthren-9-yl)-N,N′-bis(phenyl)benzidine
N,N,N′,N′-tetranaphthalen-2-ylbenzidine
2,2′-bis(N,N-diphenylamino)-9,9-spirobifluorene
9,9-bis[4-(N,N-bis(naphthalen-2-yl)amino)phenyl]-9H-fluorene
9,9-bis[4-(N,N′-bis(naphthalen-2-yl)-N,N′-bis(phenyl)amino)phenyl]-9H-fluorene titanium oxide phthalocyanine copper phthalocyanine
2,3,5,6-tetrafluoro-7,7,8,8-tetracyanoquinodimethane
4,4′,4″-tris(N-3-methylphenyl-N-phenylamino)triphenylamine
4,4′,4″-tris(N-(2-naphthyl)-N-phenylamino)triphenylamine
4,4′,4″-tris(N-(1-naphthyl)-N-phenylamino)triphenylamine
4,4′,4″-tris(N,N-diphenylamino)triphenylamine pyrazino[2,3-f][1,10]phenanthroline-2,3-dicarbonitrile
N,N,N′,N′-tetrakis(4-methoxyphenyl)benzidine
2,7-bis[N,N-bis(4-methoxyphenyl)amino]-9,9-spirobifluorene
2,2′-bis[N,N-bis(4-methoxyphenyl)amino]-9,9-spirobifluorene
N,N′-di(naphthalen-2-yl)-N,N′-diphenylbenzene-1,4-diamine
N,N′-diphenyl-N,N′-di[4-(N,N-ditolylamino)phenyl]benzidine
N,N′-diphenyl-N,N′-di[4-(N,N-diphenylamino)phenyl]-benzidine.

Below is a list of selected ionic liquids which are likewise employed as a matrix in OLEEC components:
1-benzyl-3-methylimidazolium hexafluorophosphate
1-butyl-2,3-dimethylimidazolium hexafluorophosphate
1-butyl-3-methylimidazolium hexafluorophosphate
1-ethyl-3-methylimidazolium hexafluorophosphate
1-hexyl-3-methylimidazolium hexafluorophosphate
1-butyl-1-(3,3,4,4,5,5,6,6,7,7,8,8,8-tridecafluoro-octyl)imidazolium hexafluorophosphate
1-methyl-3-(3,3,4,4,5,5,6,6,7,7,8,8,8-tridecafluoro-octyl)imidazolium hexafluorophosphate
1-methyl-3-octylimidazolium hexafluorophosphate
1-butyl-2,3-dimethylimidazolium tetrafluoroborate
1-butyl-3-methylimidazolium tetrafluoroborate
1-ethyl-3-methylimidazolium tetrafluoroborate
1-hexyl-3-methylimidazolium tetrafluoroborate
1-methyl-3-octylimidazolium tetrafluoroborate
1-butyl-3-methylimidazolium trifluoromethanesulfonate
1-ethyl-3-methylimidazolium trifluoromethanesulfonate
1,2,3-trimethylimidazolium trifluoromethanesulfonate
1-ethyl-3-methylimidazolium bis(pentafluoroethylsulfonyl)imide
1-butyl-3-methylimidazolium bis(trifluoromethyl-sulfonyl)imide
1-butyl-3-methylimidazolium methanesulfonate tetrabutylammonium bistrifluoromethanesulfonimidate tetrabutylammonium methanesulfonate tetrabutylammonium nonafluorobutanesulfonate tetrabutylammonium heptadecafluorooctanesulfonate tetrahexylammonium tetrafluoroborate tetrabutylammonium trifluoromethanesulfonate tetrabutylammonium benzoate tetrabutylammonium chloride tetrabutylammonium bromide
1-benzyl-3-methylimidazolium tetrafluoroborate trihexyltetradecylphosphonium hexafluorophosphate tetrabutylphosphonium methanesulfonate tetrabutylphosphonium tetrafluoroborate tetrabutylphosphonium bromide
1-butyl-3-methylpyridinium bis(trifluoromethyl-sulfonyl)imide
1-butyl-4-methylpyridinium hexafluorophosphate
1-butyl-4-methylpyridinium tetrafluoroborate sodium tetraphenylborate tetrabutylammonium tetraphenylborate sodium tetrakis(1-imidazolyl)borate cesium tetraphenylborate

Some examples for synthesis of the iTMCs according to the invention:

### EXAMPLE 1

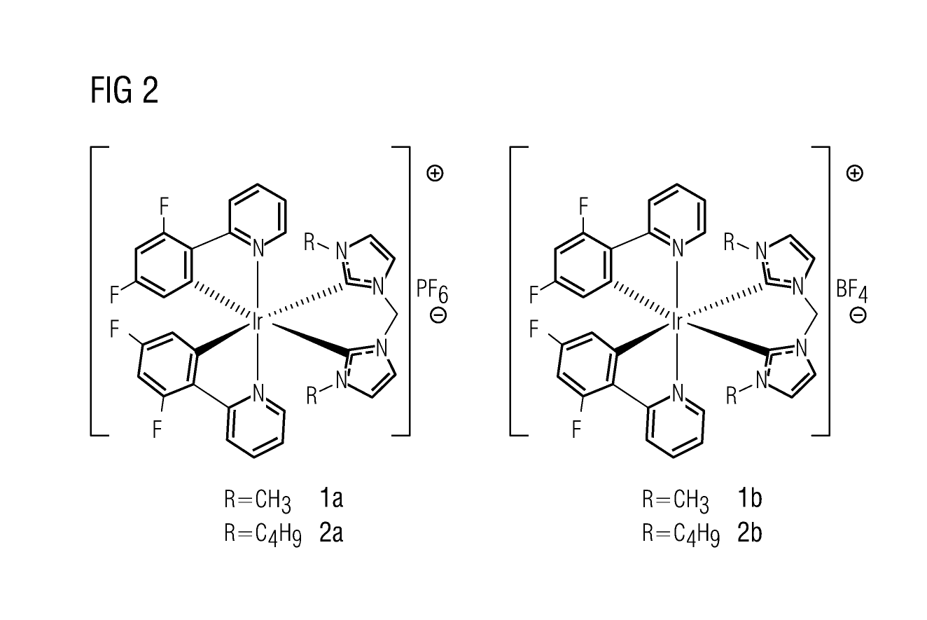

The two cationic blue-emitting heteroleptic iridium 3+-based metal complexes shown in FIG. 2 with two difluorophenylpyridine and a methyl-substituted (1a+1b) or n-butyl-substituted (2a+2b) bisimidazolium salt were synthesized.

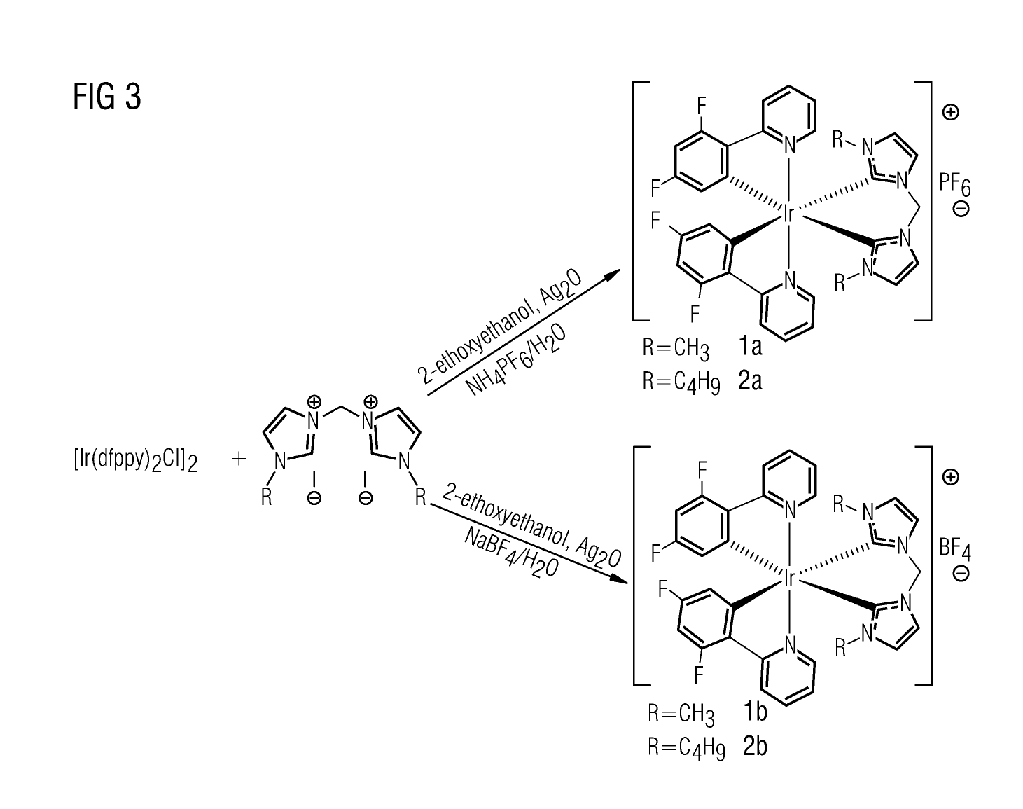

FIG. 3 shows the synthesis and characterization of cationic blue-emitting heteroleptic Ir(III)-based metal complexes with two difluorophenylpyridine ligands and a methyl-substituted (1a+b) or n-butyl-substituted (2a+b) bisimidazolium salt-like carbene ligand.

### Material Synthesis (FIG. 3):

The methyl- and n-butyl-substituted bisimidazolium salts (L1 and L2) were obtained from the reaction of 1-methylimidazolium, 1-n-butylimidazolium and diiodomethane in THF [1]. The iridium complex [(dfppy)₂Ir(μ-Cl)]₂ was synthesized from IrCl₃.nH₂O and 4,6-difluorophenylpyridine in 2-ethoxyethanol according to literature [2]. The solvents were dried by a standard procedure. All other reagents were (unless stated explicitly in the text) processed without any changes in the original state from the manufacturer.

### Synthesis of 1,1′-dimethyl-3,3′-methylenediimidazolium diiodide (L1)

1-Methylimidazole (12 mmol, 1.0 g, 0.97 ml) and diiodomethane (6 mmol, 1.61 g, 0.5 ml) were dissolved in 2 ml of tetrahydrofuran in a pressure tube stub. The reaction mixture was stirred at 110° C. for 1 h until a white precipitate formed. The solid was filtered out and purified with tetrahydrofuran (5 ml) and toluene (5 ml). Subsequently, the product was dried under reduced pressure and obtained as a white powder (2.31 g, 5.2 mol, 89%).

Spectrum: 1H NMR (300 MHz, DMSO): δ 9.40 (s, 1H), 7.99 (t, J=1.8, 1H), 7.81 (t, J=1.8, 1H), 6.67 (s, 1H), 3.90 (s, 3H).

### Synthesis of 1,1′-di-n-butyl-3,3′-methylenediimidazolium diiodide (L2)

1-n-Butylimidazole (7.6 mmol, 0.945 g, 1.0 ml) and diiodomethane (3.8 mol, 1.013 g, 0.30 ml) were dissolved in 2 ml of tetrahydrofuran in a closed tube. The reaction mixture was stirred at 110° C. for 3 h until a white precipitate formed. The solid was filtered out and purified with tetrahydrofuran (5 ml) and toluene (5 ml). Subsequently, the product was dried under reduced pressure and obtained as a white powder (3.22 g, 6.2 mmol, 82%).

Spectrum: 1H NMR (300 MHz, DMSO): δ 9.47 (s, 1H), 8.01 (t, J=1.7, 1H), 7.92 (t, J=1.8, 1H), 6.64 (s, 1H), 4.23 (t, J=7.2, 2H), 2.00-1.66 (m, 2H), 1.29 (dq, J=7.3, 14.6, 2H), 0.90 (t, J=7.3, 3H).

### Synthesis of complex 1a bis[2-(4,6-difluorophenyl)-pyridinato-N,C2]iridium(III)[1,1′-dimethyl-3,3′-methylenediimidazoline-2,2′-diylidene]hexafluorophosphate

A mixture of 1,1′-dimethyl-3,3′-methylenediimidazolium diiodide (0.036 g, 0.83 mmol), Ag₂O (0.04 g, 0.17 mmol) and a dichloro-bridged cyclometallized iridium complex [(dfppy)₂Ir(μ-Cl)]₂ (0.05 g, 0.04 mmol) in 2-ethoxyethanol (10 ml) was heated under reflux in darkness for 12 hours. After cooling to room temperature, the solution was filtered through a glass frit and (10 equivalents of) NH₄ PF₆ (in 20 ml of H₂O) were added to initiate the precipitation. The yellow precipitate was filtered off, cleaned with H₂O and dried under reduced pressure. The solid was purified by means of silica gel column chromatography (CH₂Cl₂:MeCN=9:1) and the resulting end product was a yellowish complex 1a (0.052 g, 0.058 mmol, 72% yield).

Spectrum: 1H NMR (300 MHz, acetone): δ 8.55 (dd, J=0.8, 5.9, 1H), 8.41 (d, J=8.6, 1H), 8.10 (ddd, J=0.5, 4.5, 8.3, 1H), 7.56 (d, J=1.9, 1H), 7.30 (ddd, J=1.4, 5.9, 7.3, 1H), 7.25 (d, J=1.9, 1H), 6.58 (ddd, J=2.4, 9.2, 12.9, 1H), 6.39 (s, 1H), 5,92 (dd, J=2.4, 8.5, 1H), 3.01 (s, 3H).

High-resolution mass spectroscopy found 749.1613 u ([M-PF₆]⁺). Elemental analysis calculated for C₃₁H₂₄F₁₀IrN₆P: C, 41.66; H, 2.71; N, 9.40. Found: C, 41.53; H, 2.84; N, 9.46%.

### Synthesis of complex 1b bis[2-(4,6-difluorophenyl)-pyridinato-N,C2]iridium(III)[1,1′-dimethyl-3,3′-methylenediimidazoline-2,2′-diylidene]tetrafluoroborate

A mixture of 1,1′-dimethyl-3,3′-methylenediimidazolium diiodide (0.36 g, 8.3 mmol), Ag₂O (0.4 g, 1.7 mmol) and a dichloro-bridged cyclometallized iridium complex [(dfppy)₂Ir(μ-Cl)]₂ (0.5 g, 0.4 mmol) in 2-ethoxyethanol (10 ml) was heated under reflux in darkness for 12 hours. After cooling to room temperature, the solution was filtered through a glass frit and (10 equivalents of) NH₄ PF₆ (in 20 ml of H₂O) were added to initiate the precipitation. The yellow precipitate was filtered out, cleaned with H₂O and dried under vacuum conditions. The solid was purified by means of silica gel column chromatography (CH₂Cl₂:MeCN=9:1) and the resulting end product was a yellowish complex 1b (0.46 g, 0.56 mmol, 68% yield).

Spectrum: 1H NMR (300 MHz, acetone): δ 8.60-8.51 (m, 1H), 8.46-8.35 (m, 1H), 8.16-8.03 (m, 1H), 7.58 (d, J=2.0, 1H), 7.31 (ddd, J=1.4, 5.9, 7.4, 1H), 7.23 (d, J=2.0, 1H), 6.57 (ddd, J=2.4, 9.2, 12.9, 1H), 6.38 (s, 1H), 5.92 (dd, J=2.4, 8.5, 1H), 3.00 (s, 3H). High-resolution mass spectroscopy found 749.1635 u ([M-BF₄]⁺). Elemental analysis calculated for C₃₁H₂₄BF₈IrN₆: C, 44.56; H, 2.90; N, 10.06. Found: C, 44.09; H, 2.92; N, 9.84%.

### Synthesis of complex 2a bis[2-(4,6-difluorophenyl)-pyridinato-N,C2]iridium(III)[1,1′-di-n-butyl-3,3′-methylenediimidazoline-2,2′-diylidene]hexafluorophosphate

A mixture of 1,1′-dimethyl-3,3′-methylenediimidazolium diiodide (0.045 g, 0.087 mmol), Ag₂O (0.04 g, 0.17 mmol) and a dichloro-bridged cyclometallized iridium complex [(dfppy)₂Ir(μ-Cl)]₂ (0.05 g, 0.04 mmol) in 2-ethoxyethanol (10 ml) was heated under reflux in darkness for 12 hours. After cooling to room temperature, the solution was filtered through a glass frit and (10 equivalents of) NH₄ PF₆ (in 20 ml of H₂O) were added to initiate the precipitation. The yellow precipitate was filtered out, cleaned with H₂O and dried under vacuum conditions. The solid was removed by means of silica gel column chromatography (CH₂Cl₂:MeCN=9:1) and the resulting end product was a yellowish complex 2a (0.056 g, 0.057 mmol, 79% yield).

Spectrum: 1H NMR (300 MHz, acetone): δ 8.51 (dd, J=0.8, 5.9, 1H), 8.48-8.40 (m, 1H), 8.11 (ddd, J=0.9, 7.5, 8.3, 1H), 7.61 (d, J=2.0, 1H), 7.39-7.29 (m, 2H), 6.60 (ddd, J=2.4, 9.2, 12.9, 1H), 6.35 (s, 1H), 5.87 (dd, J=2.4, 8.5, 1H), 3.59-3.33 (m, 2H), 1.29-1.09 (m, 1H), 0.94-0.74 (m, 2H), 0.65 (t, J=7.2, 3H), 0.52-0.30 (m, 1H). High-resolution mass spectroscopy found 833.2576 u ([M-PF₆]⁺). Elemental analysis calculated for C₃₇H₃₆F₁₀IrN₆P: C, 45.44; H, 3.71; N, 8.59. Found: C, 44.04; H, 3.62; N, 8.41%.

### Synthesis of complex 2b bis[2-(4,6-difluorophenyl)-pyridinato-N,C2]iridium(III)[1,1′-di-n-butyl-3,3′-methylenediimidazoline-2,2′-diylidene]tetrafluoroborate

A mixture of 1,1′-dimethyl-3,3′-methylenediimidazolium diiodide (0.045 g, 0.087 mmol), Ag₂O (0.04 g, 0.17 mmol) and a dichloro-bridged cyclometallized iridium complex [(dfppy)₂Ir(μ-Cl)]₂ (0.05 g, 0.04 mmol) in 2-ethoxyethanol (10 ml) was heated under reflux in darkness for 12 hours. After cooling to room temperature, the solution was filtered through a glass frit and (10 equivalents of) NH₄ PF₆ (in 20 ml of H₂O) were added to initiate the precipitation. The yellow precipitate was filtered out, cleaned with H₂O and dried under vacuum conditions. The solid was purified by means of silica gel column chromatography (CH₂Cl₂:MeCN=9:1) and the resulting end product was a yellowish complex 2b (0.055 g, 0.09 mmol, 74% yield).

Spectrum: 1H NMR (300 MHz, acetone): δ 8.52 (dd, J=0.8, 5.9, 1H), 8.43 (d, J=8.7, 1H), 8.11 (dd, J=7.7, 8.5, 1H), 7.64 (d, J=2.0, 1H), 7.39-7.26 (m, 2H), 6.60 (ddd, J=2.4, 9.2, 12.9, 1H), 6.34 (s, 1H), 5.87 (dd, J=2.4, 8.5, 1H), 3.58-3.35 (m, 2H), 1.19 (td, J=5.8, 10.9, 1H), 0.96-0.72 (m, 2H), 0.65 (t, J=7.2, 3H), 0.53-0.27 (m, 1H). High-resolution mass spectroscopy found 833.2558 u ([M-PF₄]⁺). Elemental analysis calculated for C₃₇H₃₆BF₈IrN₆: C, 48.32; H, 3.95; N, 9.14. Found: C, 48.01; H, 4.03; N, 9.05%.

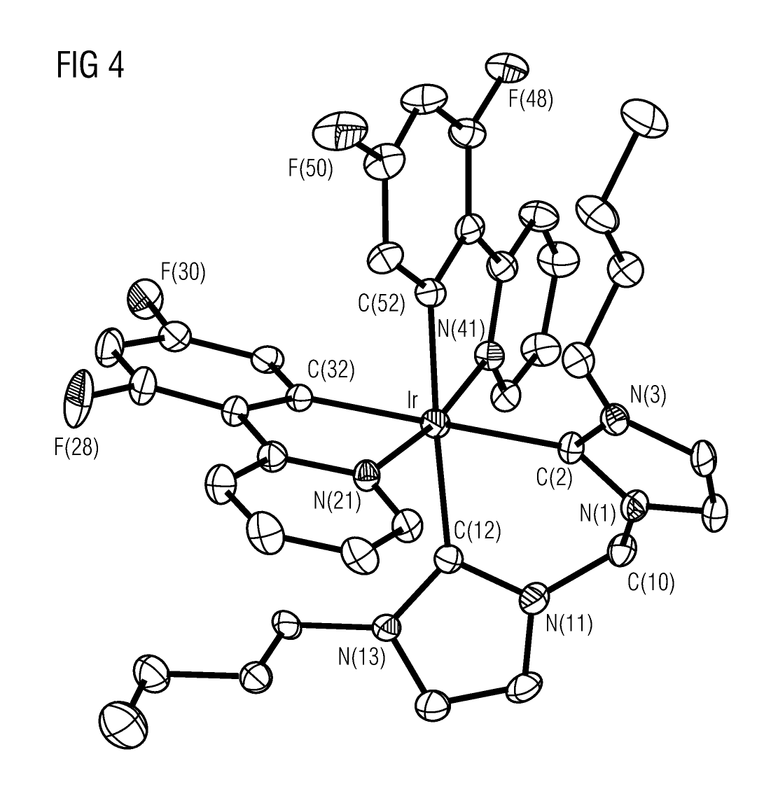

### X-Ray Characterization (FIG. 4)

FIG. 4 shows the ORTEP diagram of compound 2a with thermal ellipsoids at a 30% probability level. For better clarity, the acetonitrile solvent molecules, the counterions and the hydrogen atoms have been omitted.

FIG. 5 shows the accompanying crystallography data.

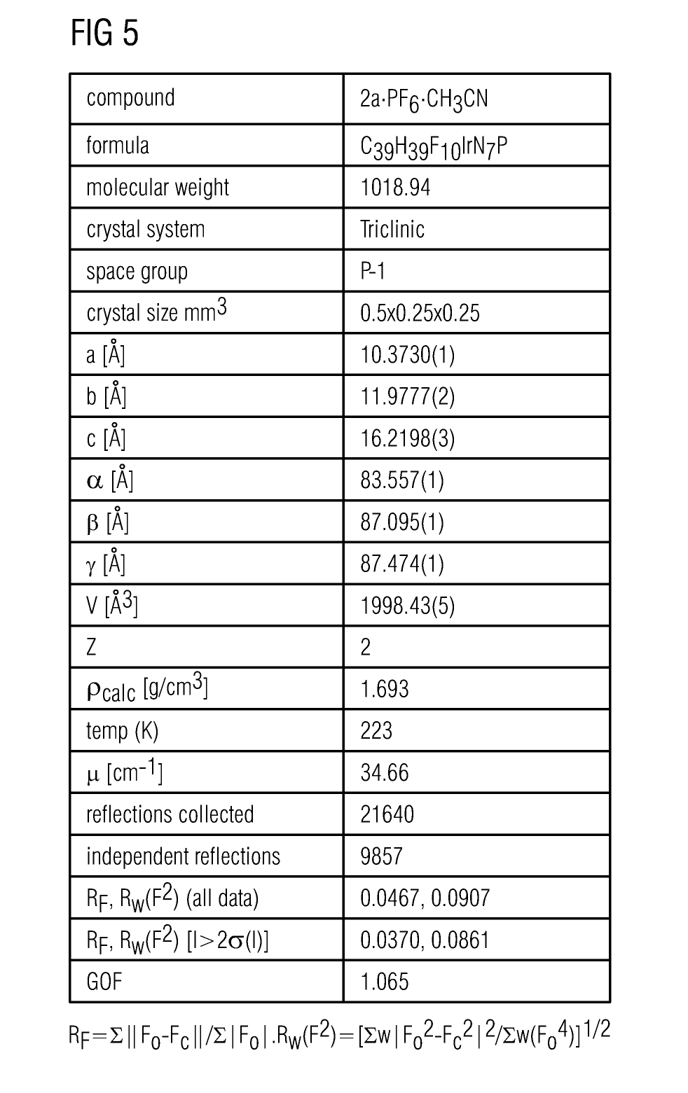

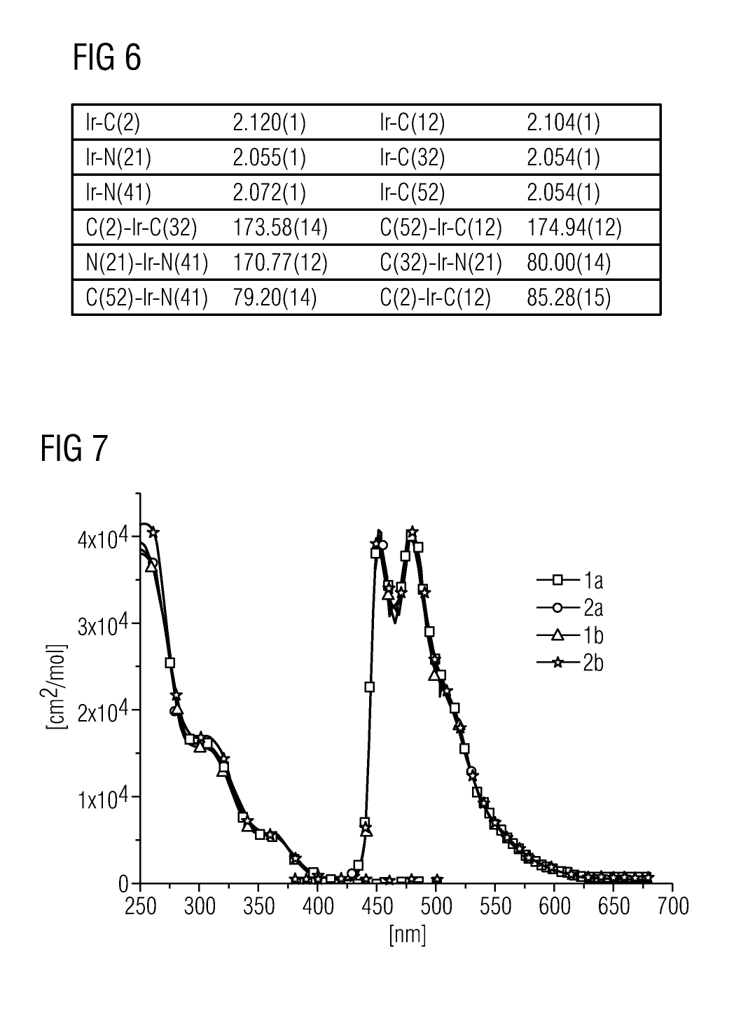

FIG. 6 shows selected bond lengths in angstrom and angles thereof.

FIG. 7 shows the absorption spectrum in a DCM solution at room temperature.

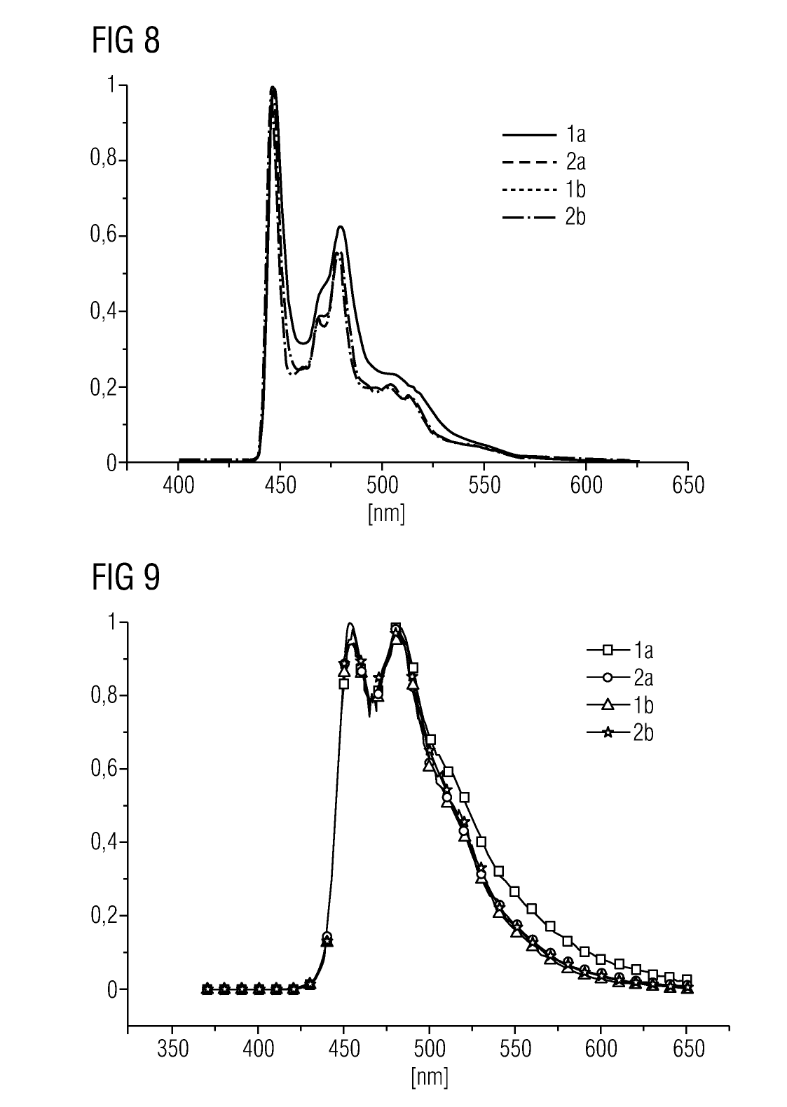

FIG. 8 shows the emission spectrum of complexes 1a, 1b, 2a and 2b at 77 K.

FIG. 9 shows the emission spectrum of the complexes in a PMMA film in a concentration of 5%.

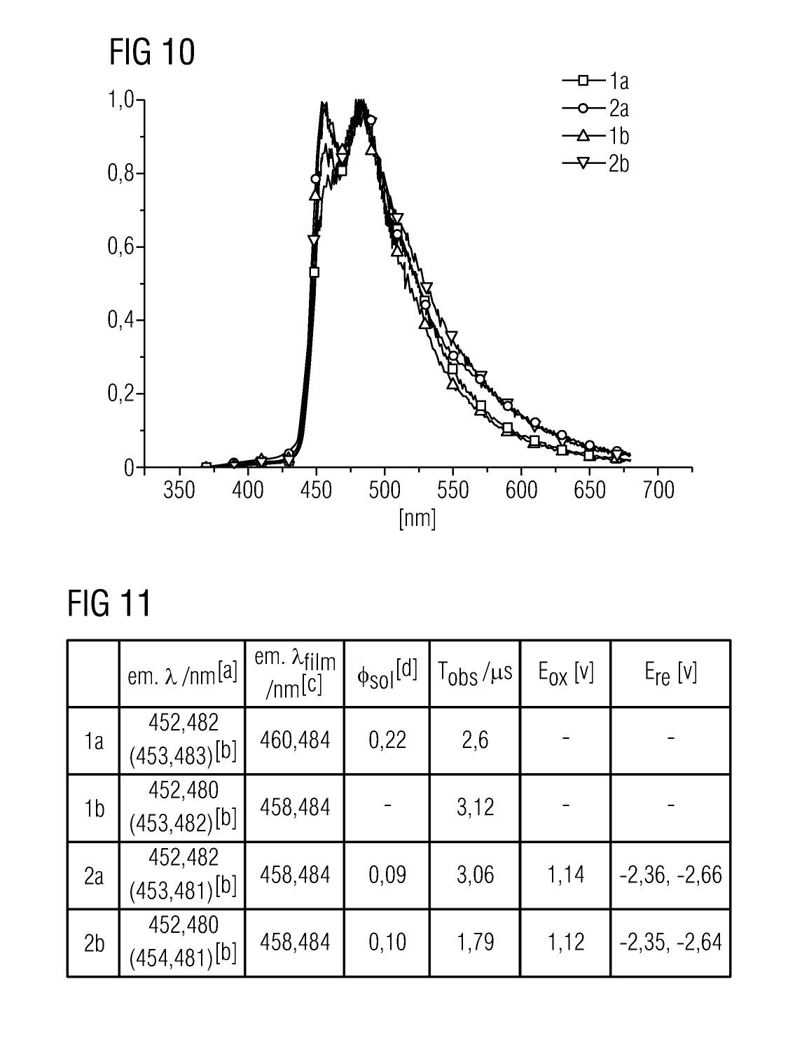

FIG. 10 shows the emission spectrum of the complexes in an NEAT film.

FIG. 11 shows the photophysical and electrochemical data of the complexes.

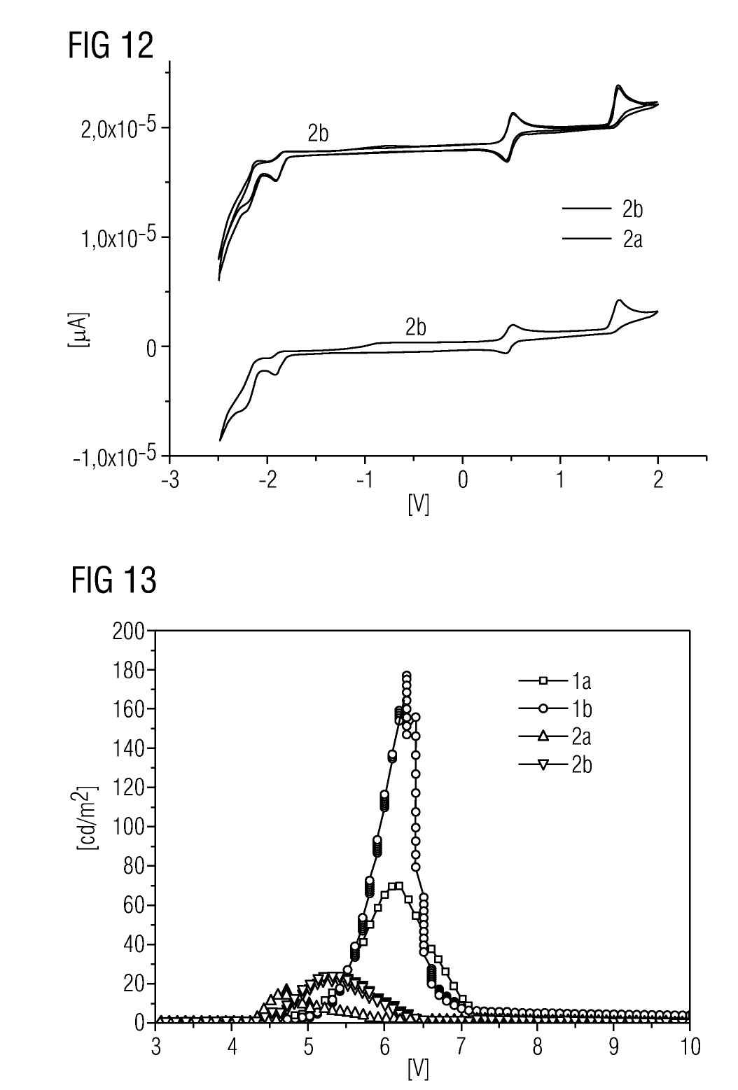

FIG. 12 shows the cyclic voltammogram of complexes 2a, 2b (PF₆ and BF₄).

FIG. 13 shows the luminance as a function of the voltage for OLEECs of the carbene type.

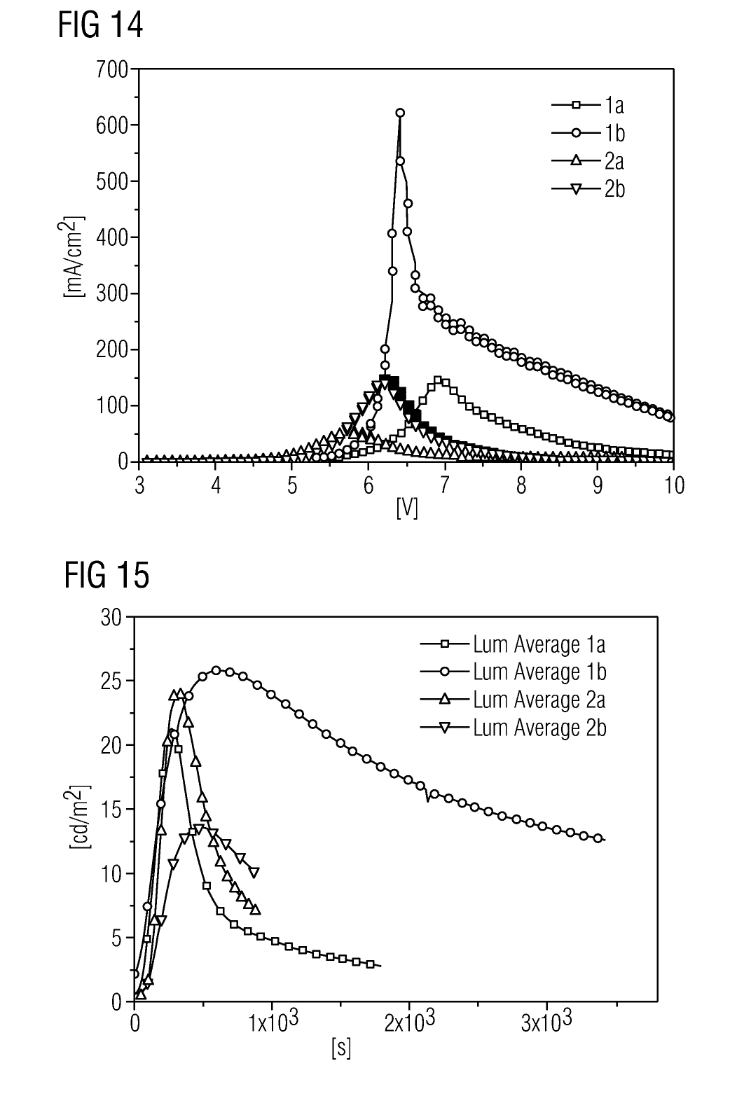

FIG. 14 shows the current densities for the OLEECs from FIG. 13.

FIG. 15 shows the long-term stability thereof.

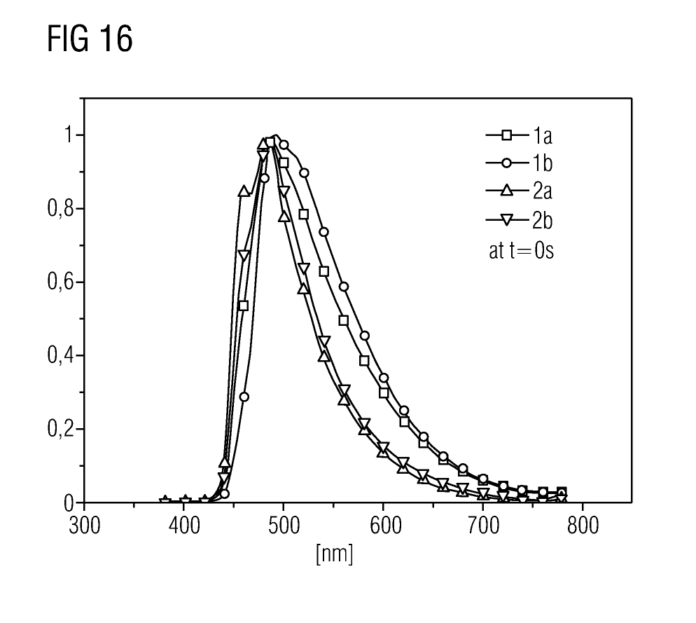

FIG. 16 shows the corresponding electroluminescence spectrum.

In order to obtain crystal structures of complex 2a which can be studied by means of X-ray diffraction methods (ORTEP diagram), diethyl ether was evaporated gradually into an acetonitrile solution of the complex. As shown in FIG. 4, 2a features a twisted octahedral geometry around the Ir atom with cyclometallized dfppy ligands and a 1,1′-di-n-butyl-3,3′-methylenediimidazole ligand. The dfppy ligands assume a staggered configuration, where the nitrogen atoms N(21) and N(41) are in a trans position with the distances Ir—N(21)=2.055(1) and Ir—N(41)=2.072 (1) Å.

The substituted phenyl groups are mutually aligned in cis configuration with distances of Ir—C(32)=2.054(1) and Ir—C(52)=2.054 (1) Å.

### Photophysical Characterization

FIGS. 7 to 10 show UV/Vis absorption and emission spectra of complexes 1˜2 dissolved in CH₂Cl₂. In general, the dominant absorption bands for the wavelength range of ≦300 nm are assigned to spin-allowed 1ππ* transitions of the ligands. The structureless band between ˜300-360 nm for 1˜2 can be attributed to an overlap of the fluorine-substituted phenyl-to-pyridine inter-ligand ππ* transfer (LLCT: ligand-ligand charge transfer) with the Ir(dπ) metal to pyridyl ligand transfer (MLCT: metal-ligand charge transfer). Complexes 1˜2 emit in the blue wavelength range with peak wavelengths of ˜452 nm in degassed CH₂Cl₂ solution. The PL spectrum of the complexes does not have any significant difference. All complexes exhibit vibronically structured emission spectra at room temperature, which indicates that the light-emitting excited states have predominantly a ³LC ππ* character as well as ³MLCT or ³LLCT character. The quantum yield Φ=0.2 of complexes 1˜2 was measured in an Ulbricht sphere in degassed CH₂Cl₂.

### Electrochemical Characterization

The electrochemical characteristics of these Ir metal complexes were examined by means of cyclic voltametry with ferrocene as the internal standard. The results are listed in FIG. 11. As shown in FIG. 12, complexes 2a and 2b have quasi-reversible oxidation processes and irreversible reduction processes in MeCN solution.

### Component Production and Characterization

The active area of an OLEEC component is, for example, 4 mm². The components were produced by means of spin-coating techniques on indium tin oxide (ITO) glass substrates with vapor-deposited Al cathodes. The component consists of 100 nm of poly(3,4-ethylenedioxy-thiophene):poly(styrenesulfonate) (PEDOT:PSS) and 70 nm of the iTMC complex including tetrabutylammonium trifluoromethanesulfonate as the ion conductor. PEDOT:PSS (Clevios AI4083) was purchased here from H. C. Starck, and tetrabutylammonium trifluoromethane-sulfonate from Sigma Aldrich. The emission layer was prepared as follows: 10 mg of the iTMC complex were dissolved together with the ion conductor in 1 ml of acetonitrile in a molar ratio of 1:1. Before the spin-coating, the solution was filtered with a 0.1 μm PTFE filter. The wet film was dried at 80° C. in a vacuum oven for 2 hours.

Finally, the cathode consisting of 150-200 nm of Al was applied by vapor deposition and encapsulated with a glass lid in order to prevent interactions of the organic layers with air molecules and water.

In order to study the electroluminescent properties of the components, LIV measurements (variable voltage) and lifetime measurements (constant voltage) were conducted. In the case of the LIV measurements, the current density and the luminance were measured as a function of voltage commencing at 0 V (time 0 s) to 10 V in steps of 0.1 V, and the voltage was increased every 60 s. In the lifetime measurements, the voltage was set at a constant 5.0 V and the current density and luminance were recorded every 10 s. All electrical characterizations were conducted with an E3646A voltage supply from Agilent Technologies. The light emission was registered by means of photodiodes. The current through the component and the photocurrent were detected by means of NI9219 current meters from National Instruments. The current limit was set to 40 mV. With the aid of a spectral camera (PR650), the photodiode current was calibrated, and the electroluminescence spectrum was detected in the visible wavelength range between 380 and 780 nm.

FIGS. 13 and 14 show typical LIV measurements of complexes 1a+b and 2a+b. For all components, a peak-shaped characteristic of the current density and luminance is observed, and the components begin to glow (turn on) at voltages between 4.0 and 5.0 V. Complexes 1a and 1b have higher luminances (70 cd/m² and 180 cd/m² respectively) than complexes 2a and 2b (both approx. 20 cd/m²). In addition, the influence of the counterions is significant (particularly for complex 1): it is found that the luminances for complex 1b with the smaller BF₄⁻ ion (Lum≈180 cd/m²) are higher than for complex 1a with the larger PFC ion (Lum≈70 cd/m²).

The observed decline in the luminance for higher voltages >6.5 V can be attributed to component instabilities at higher electrical fields.

FIG. 15 depicts time-dependent measurements of the luminance of the carbene-based iTMCs. The characteristics shown were averaged here over six components. The best results with regard to long-term stability were achieved here for complex 1b with a BF₄⁻ counterion. The turn-on time (time until attainment of maximum luminance) varies here between 260 s (1a) and 620 s (1b).

FIG. 16 shows the emission spectrum for an applied voltage of 5.5 V. Particularly iTMC complexes 2a and 2b emit in the blue-green wavelength range with a local maximum at 456 nm and 488 nm.

1. A phosphorescent metal complex, comprising:
at least one metallic central atom M; and
at least one ligand coordinated by the metallic central atom,
wherein one ligand is bidentate with two uncharged coordination sites and comprises at least one carbene unit coordinated directly to the metal atom.

2. The complex as claimed in claim 1,
wherein the carbene unit is selected from the group of the pyridinatocarbenes.

3. The complex as claimed in claim 1, which is bridged.

4. The complex as claimed in claim 1,
wherein the metallic central atom is selected from the group of the following metals: Ir, Re, Os, Au, Hg, Ru, Rh, Pd, Ag, lanthanides, Cu.

5. The complex as claimed in claim 1,
wherein the bidentate ligand has two uncharged carbene units, both of which coordinate to the metal center.

6. The complex as claimed in claim 1,
which has at least one of the structural formulae 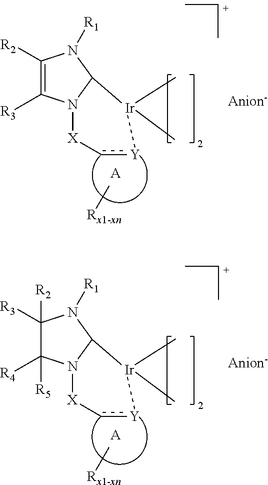
where:
M=Ir, Re, Os, Au, Hg, Ru, Rh, Pd, Ag, Cu
Y═C—R1R2, N—R, O, Si—R1R2 and/or P—R
R=independently H, branched alkyl radicals, unbranched alkyl radicals, fused alkyl radicals, cyclic alkyl radicals, fully or partly substituted unbranched alkyl radicals, fully or partly substituted branched alkyl radicals, fully or partly substituted fused alkyl radicals, fully or partly substituted cyclic alkyl radicals, alkoxy groups, amines, amides, esters, carbonates, aromatics, fully or partly substituted aromatics, heteroaromatics, fused aromatics, fully or partly substituted fused aromatics, heterocycles, fully or partly substituted heterocycles, fused heterocycles, halogens, pseudohalogens
and
aryl on the R radical or aryl as the R radical=any partly or fully substituted aromatic or heteroaromatic radical which may also be fused, form a bridge to a further complex and/or be fused or annelated to further aromatics or heteroaromatics, and bonded to further cyclic compounds.

7. The complex as claimed in claim 1,
which has at least one of the structural formulae 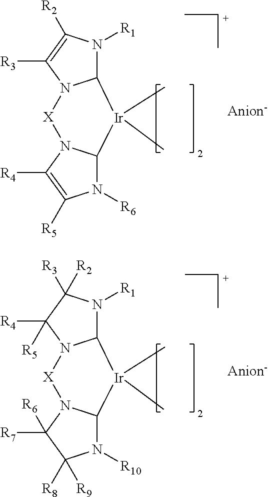
where:
M=Ir, Re, Os, Au, Hg, Ru, Rh, Pd, Ag, Cu
R=independently H, branched alkyl radicals, unbranched alkyl radicals, fused alkyl radicals, cyclic alkyl radicals, fully or partly substituted unbranched alkyl radicals, fully or partly substituted branched alkyl radicals, fully or partly substituted fused alkyl radicals, fully or partly substituted cyclic alkyl radicals, alkoxy groups, amines, amides, esters, carbonates, aromatics, fully or partly substituted aromatics, heteroaromatics, fused aromatics, fully or partly substituted fused aromatics, heterocycles, fully or partly substituted heterocycles, fused heterocycles, halogens, pseudohalogens
and
R=aryl or substituent on aryl=any partly or fully substituted aromatic or heteroaromatic radical which may also be fused, form a bridge to a further complex and/or be fused or annelated to further aromatics or heteroaromatics, and bonded to further cyclic compounds.

8. The complex as claimed in claim 7,
wherein R₁ and/or R₆ is additionally coordinated to M.

9. The complex as claimed in claim 1,
which is polynuclear and has at least two metallic central atoms M.

10. The complex as claimed in claim 9,
wherein the at least two metallic central atoms M are coordinated to one another via a metal-metal interaction.

11. The complex as claimed in claim 9,
wherein the at least two metallic central atoms M are joined via at least one additional bridge ligand.

12. A radiation-emitting component, comprising:
a substrate;
a first electrode layer on the substrate;
at least one organic emitting layer on the first electrode layer; and
a second electrode layer on the organic emitting layer, wherein the organic emitting layer comprises a phosphorescent metal complex, the phosphorescent metal complex comprising:
at least one metallic central atom M; and
at least one ligand coordinated by the metallic central atom,
wherein one ligand is bidentate with two uncharged coordination sites and
comprises at least one carbene unit coordinated directly to the metal atom.

13. The component as claimed in claim 12,
wherein the phosphorescent metal compound is embedded in a matrix material.

14. The component as claimed in claim 12,
which on application of a voltage emits light of a color selected from a group comprising the colors of green, blue green, light blue, deep blue, blue.

15. The component as claimed in claim 12,
wherein the substrate and the first electrode layer are transparent.

16. The component as claimed in claim 12,
wherein the substrate and the first and second electrode layers are transparent.

17. A process for preparing a phosphorescent metal complex,
the phosphorescent metal complex comprising:
at least one metallic central atom M; and
at least one ligand coordinated by the metallic central atom,
wherein one ligand is bidentate with two uncharged coordination sites and
comprises at least one carbene unit coordinated directly to the metal atom;
the process comprising:
providing a central atom compound of a metallic central atom, having exchange ligands coordinated to the central atom; and
mixing the central atom compound and a ligand dissolved in a first solvent to form the metal complex, the exchange ligand being replaced by the ligand which coordinates in a bidentate manner to the central atom and comprises a carbene unit.
